(19) United States
(12) Patent Application Publication
(10) Pub. No.: US 2025/0049276 A1
(43) Pub. Date: Feb. 13, 2025

(54) DUST COLLECTING ATTACHMENT

(71) Applicant: MAKITA CORPORATION, Anjo-shi (JP)

(72) Inventors: Bang WANG, Jiangsu (CN); Xiaongfei Wen, Jiangsu (CN); Yoshiro Tada, Anjo-shi (JP); Takahiro Nishikawa, Anjo-shi (JP)

(73) Assignee: MAKITA CORPORATION, Anjo-shi (JP)

(21) Appl. No.: 18/795,568

(22) Filed: Aug. 6, 2024

(30) Foreign Application Priority Data
Aug. 10, 2023 (JP) 2023-131431
May 15, 2024 (JP) 2024-079690

(51) Int. Cl. A47L 7/00; A47L 9/06; A47L 9/24; B23Q 11/00

(52) U.S. Cl. CPC A47L 7/0095; A47L 9/068; A47L 9/0693; A47L 9/248; B23Q 11/0046

(57) ABSTRACT

A dust collecting attachment includes a dust suction portion and a main body. The main body has a dust collection passage communicated with the dust suction portion. The dust suction portion has a negative pressure by exerting a suction force to the dust collection passage from a hose. The dust suction portion includes an inner pipe through which a tip tool passes, a first dust suction flow passage, and a second dust suction flow passage. The first dust suction flow passage opens a first suction opening to a side of a workpiece in an outside in a radial direction of the inner pipe and is communicated with the dust collection passage. The second dust suction flow passage opens a second suction opening to an opposite side of the workpiece in the outside in the radial direction of the inner pipe and is communicated with the dust collection passage.

### CROSS REFERENCE TO RELATED APPLICATION

This application claims the benefit of Japanese Patent Application Numbers 2023-131431 filed on Aug. 10, 2023 and 2024-079690 filed on May 15, 2024, the entirety of which is incorporated by reference.

### FIELD OF THE INVENTION

The present disclosure relates to a dust collecting attachment used for collecting the dust generated from a workpiece during an operation by an electric power tool.

### BACKGROUND OF THE INVENTION

For example, when a drilling work is performed with a tip tool using a hammer drill, a dust collecting attachment for collecting dust at a machining position without scattering the dust generated from a workpiece is used in some cases. US 2011/0142561 A discloses the example. The dust collecting attachment disclosed in US 2011/0142561 A is provided with a pipe-shaped dust suction portion through which a tip tool passes in an upper portion of a housing expanding to the right and left. The dust collecting attachment has a cylindrically-shaped handle portion having a dust collection passage communicated with the dust suction portion in a front side of the housing. Meanwhile, a suction space that is provided with a sealing material and a pad and has an open suction port is formed in a rear side of the housing.

The dust collecting attachment is used by connecting an external dust collector to the handle portion via a hose. When the dust collector is driven and the suction port is brought into contact with a surface of the workpiece, the handle portion communicated with the hose and the dust suction portion have a negative pressure, and the suction space communicated with the handle portion also has a negative pressure. Accordingly, the suction port suctions the workpiece and positioning is made. When a tip tool of an electric power tool is inserted into the dust suction portion and machining is performed, the generated dust is suctioned from the dust suction portion to be collected by the dust collector via the handle portion and the hose.

The above-described conventional dust collecting attachment is provided with the dust suction portion in the upper portion of the housing. Therefore, when it is used in a posture in which the dust suction portion and the housing are arranged in an up-down direction, the dust suctioned by the dust suction portion flows downward and is smoothly suctioned into the dust collection passage.

However, when it is used in a horizontal posture in which the dust suction portion and the housing are arranged in right and left, the dust may remain on an inner surface located on a lower side of the dust suction portion without being suctioned into the dust collection passage. In particular, a rubber cap through which the tip tool passes is often installed on an opening in an operator side of the dust suction portion for enhancing a seal performance. Therefore, there is generated a space less likely to have an air flowing between the inner surface of the dust suction portion and the rubber cap, and thus, the dust is likely to deposit in the space during the operation in the horizontal posture.

Therefore, it is an object of the present disclosure to provide a dust collecting attachment less likely to deposit dust in a dust suction portion.

### SUMMARY OF THE INVENTION

In order to achieve the above-described object, the present disclosure provides a dust collecting attachment including a dust suction portion and a main body. The dust suction portion is opposed to a surface of a workpiece. A tip tool is allowed to pass through the dust suction portion. The main body has a dust collection passage communicated with the dust suction portion and connectable to an external hose. The dust suction portion has a negative pressure by exerting a suction force to the dust collection passage from the hose. The dust suction portion includes an inner pipe through which the tip tool passes, a first dust suction flow passage, and a second dust suction flow passage. The first dust suction flow passage opens a first suction opening to a side of the workpiece in an outside in a radial direction of the inner pipe and is communicated with the dust collection passage. The second dust suction flow passage opens a second suction opening to an opposite side of the workpiece in the outside in the radial direction of the inner pipe and is communicated with the dust collection passage.

With the present disclosure, flow passages are diverged in a dust suction portion, and a space in which an air is less likely to flow is not generated in either side of a workpiece side or an opposite side thereof in the dust suction portion. Accordingly, dust is less likely to deposit in the dust suction portion.

### BRIEF DESCRIPTION OF THE DRAWINGS

FIG. 1 is a perspective view from the rear of a dust collecting attachment.

FIG. 2 is a perspective view from the front of the dust collecting attachment.

FIG. 3 is a rear view of the dust collecting attachment.

FIG. 4 is a front view of the dust collecting attachment.

FIG. 5 is a perspective view from the front of a dust suction portion with a rubber cap removed.

FIG. 6 is a perspective view from the rear of the dust suction portion with the rubber cap removed.

FIG. 7 is a front view of the dust suction portion with the rubber cap removed.

FIG. 8 is a rear view of the dust suction portion with the rubber cap removed.

FIG. 9 is a cross-sectional view enlarged along the line A-A in FIG. 3.

FIG. 10 is a cross-sectional view enlarged along the line B-B in FIG. 3.

FIG. 11 is a partial enlarged cross-sectional view of the line C-C in FIG. 4.

FIG. 12 is a rear view of the dust collecting attachment to which a cuff with a small diameter is connected.

FIG. 13 is a rear view of the dust collecting attachment to which a cuff with a large diameter is connected.

FIG. 14 is a partial enlarged cross-sectional view of the line D-D in FIG. 12.

FIG. 15 is a partial enlarged cross-sectional view of the line E-E in FIG. 13.

FIG. 16 is an explanatory view illustrating an airflow in a used state in the partial enlarged cross-sectional surface of the line A-A in FIG. 3.

FIG. 17 is a partial enlarged cross-sectional view of the line F-F in FIG. 16 in a state used in a horizontal posture.

### DETAILED DESCRIPTION OF THE INVENTION

In one embodiment of the present disclosure, a first dust suction flow passage and a second dust suction flow passage may join together in a dust collection passage.

The configuration enables efficiently guiding dust to the dust collection passage even though two dust suction flow passages are disposed in the dust suction portion.

In one embodiment of the present disclosure, the first dust suction flow passage and the second dust suction flow passage may be disposed in at least an area of a dust collection passage side in the dust suction portion.

The configuration enables bringing both the dust suction flow passages close to the dust collection passage to shorten the flow passage, thereby reducing a pressure loss and avoiding reduced dust collection efficiency.

In one embodiment of the present disclosure, a first suction opening may be formed to be larger than a second suction opening in a circumferential direction of an inner pipe.

With the configuration, the dust generated from a workpiece can be efficiently suctioned.

In one embodiment of the present disclosure, the first suction opening and the second suction opening may both be formed at an angle of 180° or more in the circumferential direction.

The configuration enables suctioning the dust with both the suction openings located in a lower side of a tip tool even when the dust collecting attachment is used in a posture in which the dust collection passage becomes horizontal, thereby effectively avoiding accumulation of the dust inside the dust suction portion.

In one embodiment of the present disclosure, the second suction opening may be formed between the inner pipe and an outer pipe disposed outside of the inner pipe, and a rib may be installed bridging between the inner pipe and the outer pipe.

The configuration enables maintaining a shape by reinforcing the second suction opening between the inner pipe and the outer pipe.

In one embodiment of the present disclosure, an opposite side of the workpiece in the dust suction portion may be provided with a removable cap that seals between the passing-through tip tool and the dust suction portion.

The configuration enables forming the second dust suction flow passage using the cap.

In one embodiment of the present disclosure, the second suction opening includes an opposite side opening portion that opens to the opposite side of the workpiece and an inner side opening portion that is communicated with the opposite side opening portion and opens to an inner circumferential surface direction of the inner pipe. The cap may obstruct the opposite side opening portion in a mounted state.

The configuration enables efficiently suctioning the dust likely to accumulate inside the cap from the inner side opening portion.

The following describes an embodiment of the present disclosure based on the drawings.

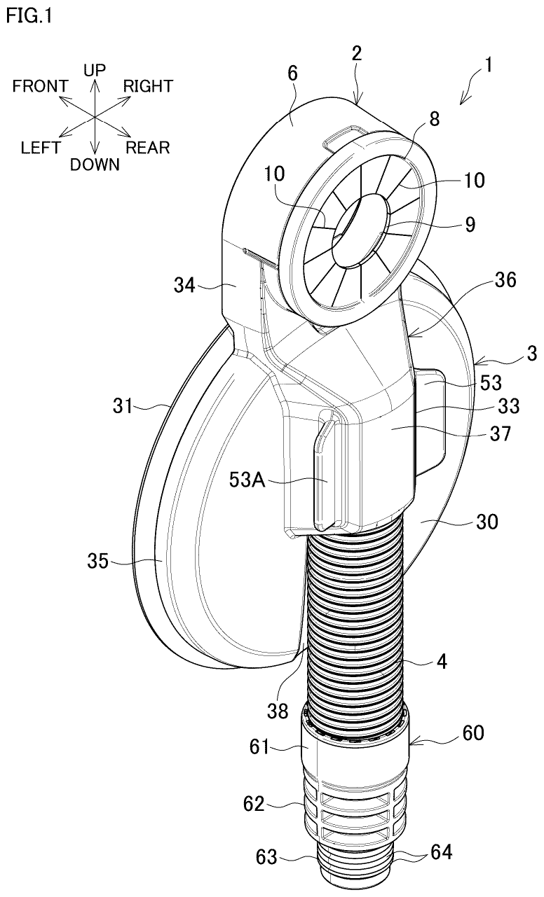

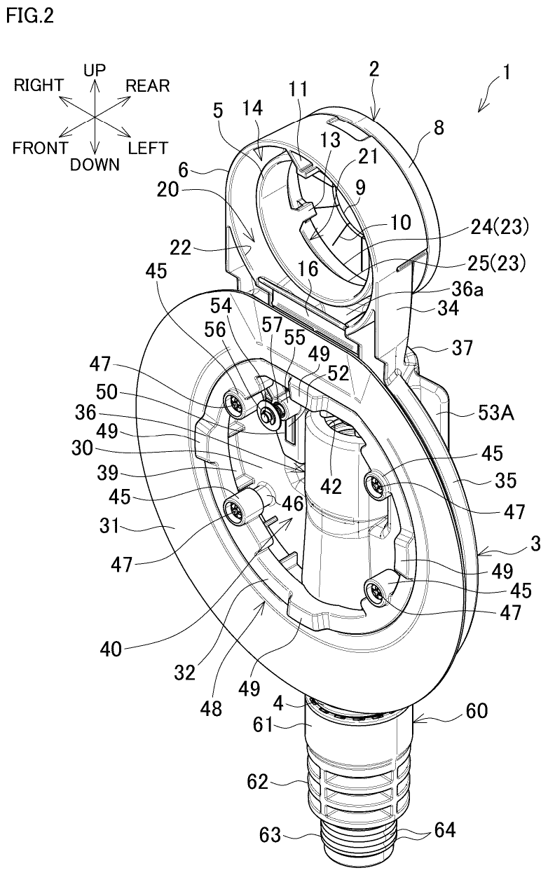

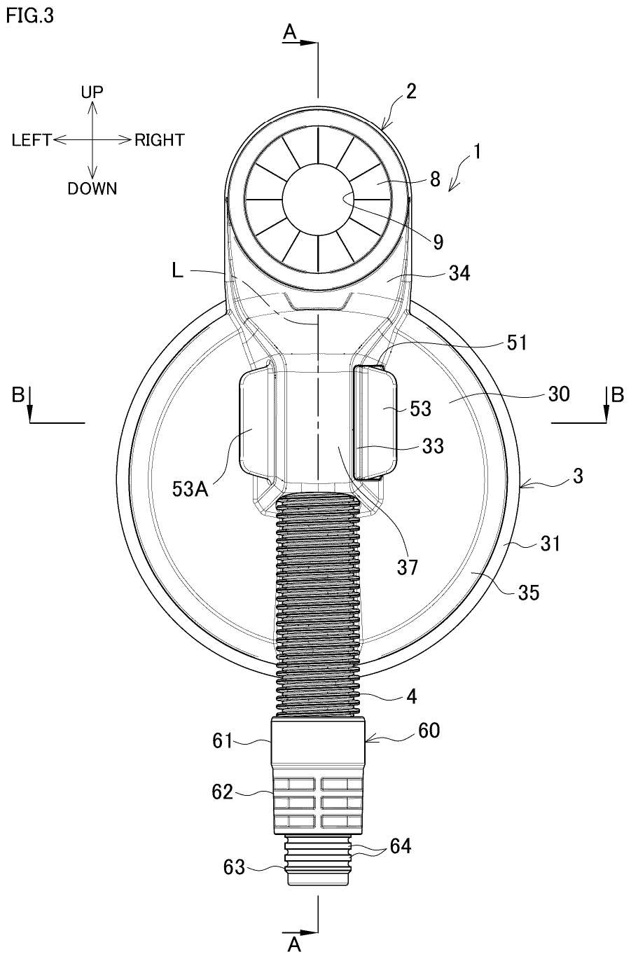

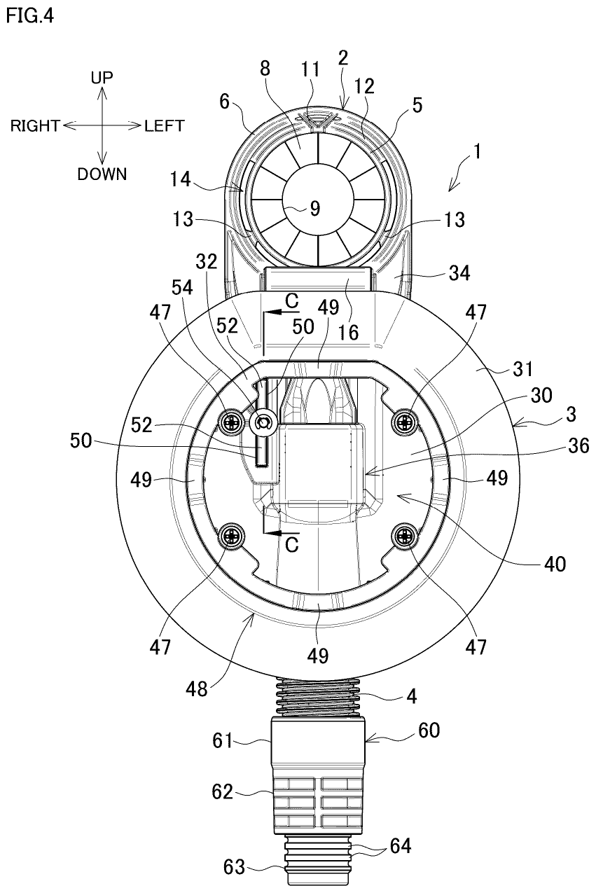

FIG. 1 is a perspective view from the rear illustrating one example of a dust collecting attachment, FIG. 2 is a perspective view from the front thereof, FIG. 3 is a rear view thereof, FIG. 4 is a front view thereof.

A dust collecting attachment 1 has a dust suction portion 2, a main body 3, and a flexible hose 4. For convenience, a description will be given with a side of the dust suction portion 2 being an upper, and a side of a suction port 48, which will be described later, in the dust suction portion 2 and the main body 3 being a front.

The dust suction portion 2 has a cylindrical shape with its axis line extending in a front-rear direction. The dust suction portion 2 includes a double pipe having an inner pipe 5 and an outer pipe 6. The inner pipe 5 has a front end located in a rear side with respect to a front end of the outer pipe 6. The inner pipe 5 has an axial length shorter than that of the outer pipe 6.

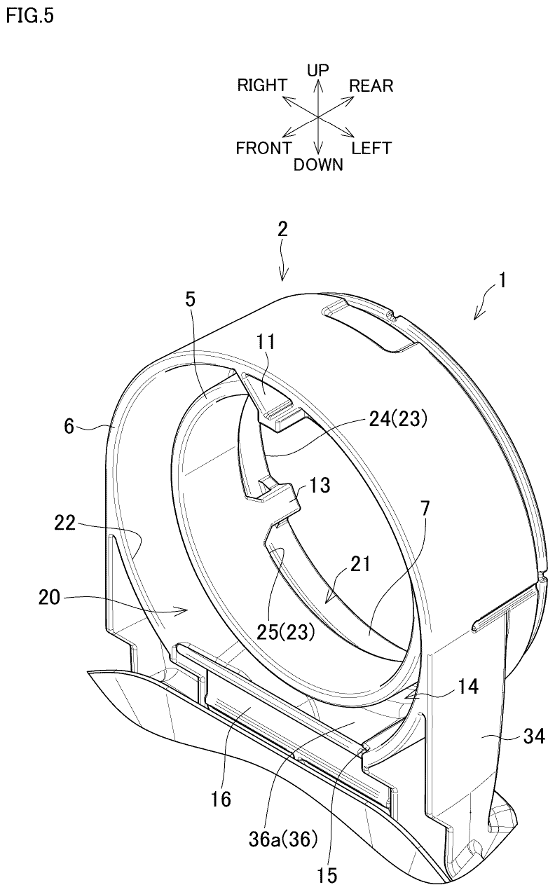

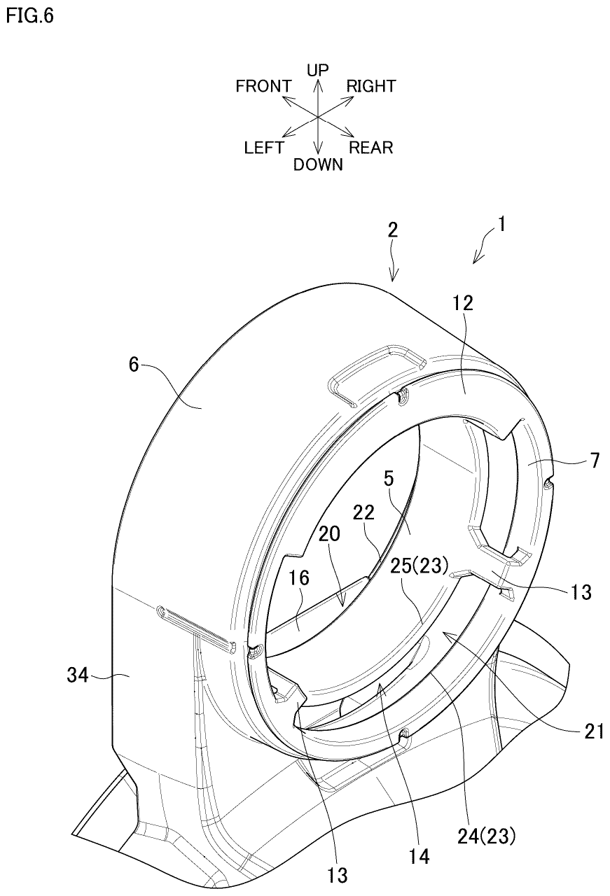

The outer pipe 6 has a rear end on which a covering portion 7 with a small diameter is coaxially formed as illustrated in FIG. 5 and FIG. 6. A rubber cap 8 removably covers the covering portion 7. The rubber cap 8 has a through-hole 9 located in the center and a plurality of cuts 10 extending in a radiation direction from the through-hole 9. The rubber cap 8 is one example of a cap of the present disclosure.

An upper connecting portion 11 is disposed between the inner pipe 5 and the outer pipe 6 immediately above the axis line of the dust suction portion 2. The upper connecting portion 11 is a rib in a V shape in front view and extends in the front-rear direction to connect the inner pipe 5 to the outer pipe 6.

A rear connecting portion 12 in an arc shape in rear view is disposed between the inner pipe 5 and the outer pipe 6 in the rear of the upper connecting portion 11. The rear connecting portion 12 connects upper portions of both the pipes at their rear ends. The rear end of the inner pipe 5 excluding the rear connecting portion 12 is located in a front side with respect to the rear end of the outer pipe 6. A pair of ribs 13 are symmetrically formed between the rear ends of both the pipes 5, 6 excluding the rear connecting portion 12 to couple both the pipes 5, 6. An inner surface of each rib 13 is a depressed curved surface continuing with the inner circumferential surface of the inner pipe 5 and extending rearward. A rear surface of each rib 13 is a planar surface continuing with a rear end surface of the outer pipe 6 and extending radially inward. The rear surface of each rib 13 is contact with a front surface of the mounted rubber cap 8.

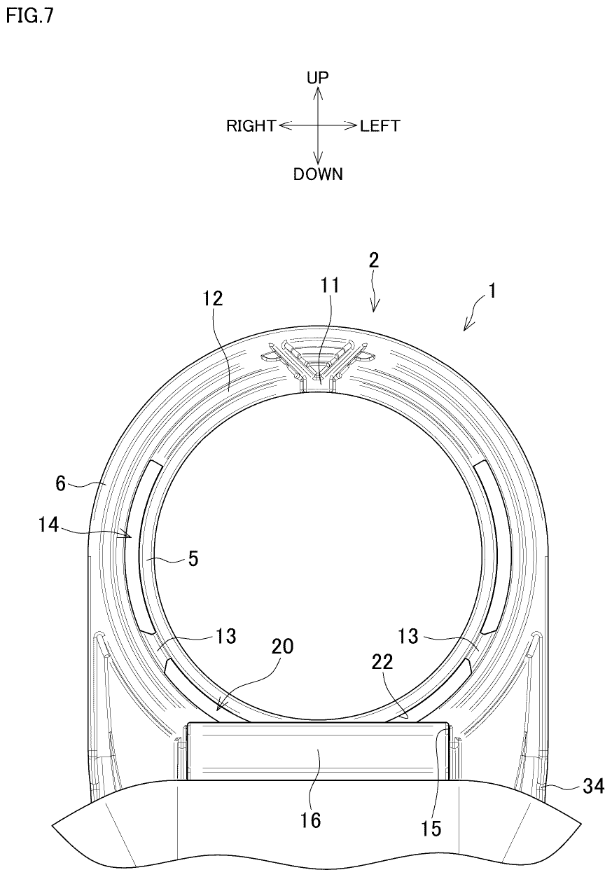

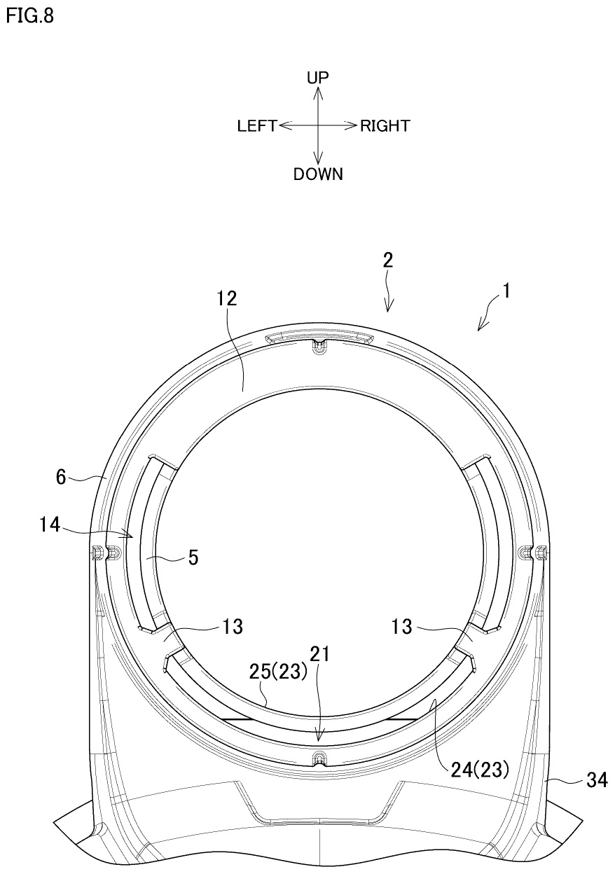

Accordingly, the inner pipe 5 and the outer pipe 6 are, as illustrated in FIG. 7 and FIG. 8, coaxially combined with one another, and form a ring-shaped ventilation space 14 continuing in the circumferential direction excluding the upper connecting portion 11 between both the pipes.

The outer pipe 6 has a lower front side where a cutout 15 is partially formed. An upper end of a partition plate 16 that forms a partition of a dust collection passage 36, which will be described later, is located in the cutout 15.

A front side dust suction flow passage 20 and a rear side dust suction flow passage 21 are formed outside in the radial direction of the inner pipe 5. The front side dust suction flow passage 20 is an example of the first dust suction flow passage of the present disclosure, and the rear side dust suction flow passage 21 is an example of the second dust suction flow passage of the present disclosure.

The front side dust suction flow passage 20 opens a front suction opening 22 to the front. The front suction opening 22 is an example of the first suction opening of the present disclosure.

The front suction opening 22 opens into a ring shape excluding the upper connecting portion 11 between the front end of the inner pipe 5 and the front end of the outer pipe 6 and an upper end of the partition plate 16 as illustrated in FIG. 5 and FIG. 7. That is, the front suction opening 22 is formed into a ring shape straddling from an area in a lower half side to an area in an upper half side of the dust suction portion 2. The area of the lower half side of the dust suction portion 2 is an example of an area in a dust collection passage side in the dust suction portion of the present disclosure.

The front side dust suction flow passage 20 is a flow passage that passes through the ventilation space 14 from the front suction opening 22 and reaches an air inlet 36a of the dust collection passage 36, which will be described later.

The rear side dust suction flow passage 21 opens a rear suction opening 23 in the rear portion. The rear suction opening 23 is an example of the second suction opening of the present disclosure. The rear suction opening 23 has a rear side opening portion 24 that opens into an arc shape excluding the rear connecting portion 12 between the rear end of the inner pipe 5 and the rear end of the outer pipe 6 in rear view as illustrated in FIG. 6 and FIG. 8. The rear side opening portion 24 is an example of the opposite side opening portion of the present disclosure.

The rear suction opening 23 also has an inner side opening portion 25 that opens into a strip shape in the circumferential direction straddling over the ribs 13 inside the rear of the inner pipe 5. The rear side opening portion 24 and the inner side opening portion 25 are communicated with one another.

Thus, the rear suction opening 23 including the rear side opening portion 24 and the inner side opening portion 25 is formed to have an angle larger than 180° in the circumferential direction of the inner pipe 5 including the area of the lower half side of the dust suction portion 2. The rear suction opening 23 is formed to be smaller than the front suction opening 22 in the circumferential direction of the inner pipe 5.

In a state where the rubber cap 8 is mounted, the rear side opening portion 24 of the rear suction opening 23 is obstructed by an outer periphery portion of the rubber cap 8. Accordingly, only the inner side opening portion 25 of the rear suction opening 23 opens in the inner pipe 5.

The rear side dust suction flow passage 21 is a flow passage that passes through the ventilation space 14 from the rear suction opening 23, and reaches the air inlet 36a of the dust collection passage 36.

The main body 3 has a main body housing 30, a pad 31, an inner frame 32, and an air vent lever 33.

The main body housing 30 is in a circular shape in rear view. The main body housing 30 has an upper portion in which a coupling portion 34 to be coupled to the dust suction portion 2 is installed consecutively in an up-down direction. The main body housing 30 has an outer periphery on which a strip-shaped skirt 35 projecting forward over the whole circumference is formed and has a front that opens.

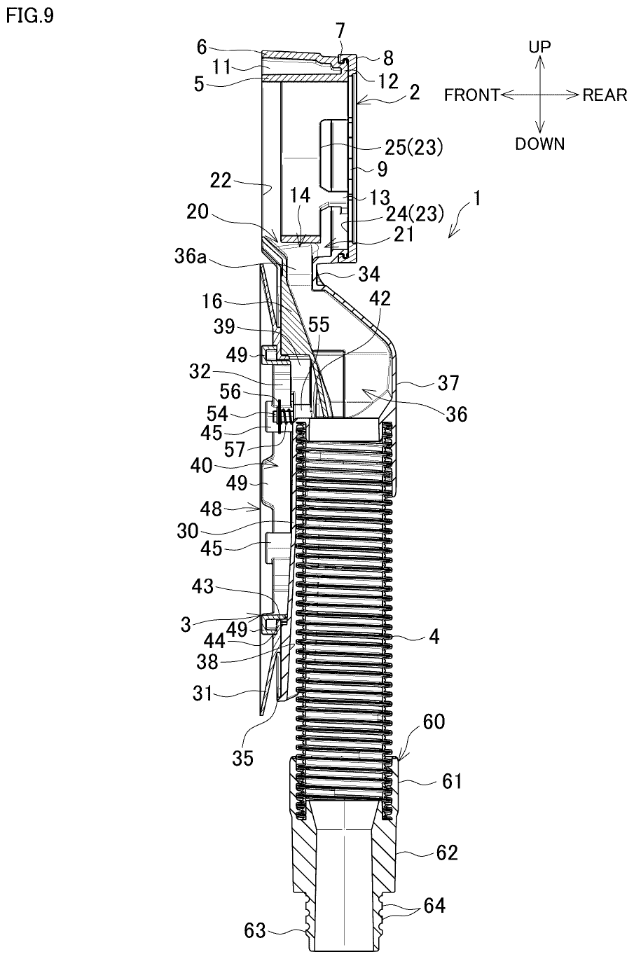

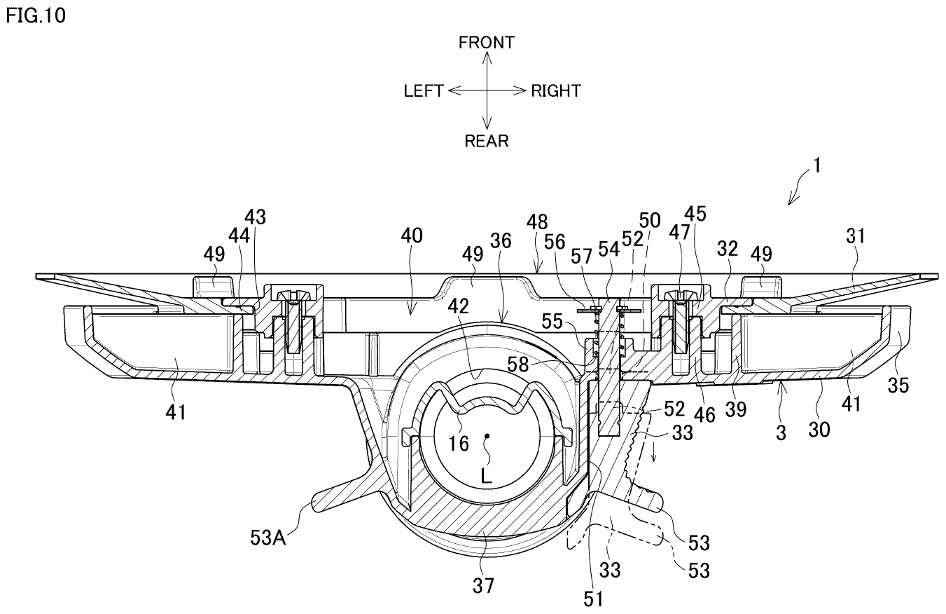

In the main body housing 30, the pipe-shaped dust collection passage 36 is formed in the up-down direction, for example, as illustrated in FIG. 9 and FIG. 10. The dust collection passage 36 passes through the coupling portion 34 in the center in the right-left direction of the main body housing 30. An upper end of the dust collection passage 36 opens the air inlet 36a to a lower inner surface of the outer pipe 6 of the dust suction portion 2. The air inlet 36a is communicated with the ventilation space 14. The dust collection passage 36 has a lower portion bulging rearward from the upper portion to the lower portion of the main body housing 30 to form a handle portion 37 on a rear surface of the main body housing 30. The handle portion 37 has a lower end that opens. On the rear surface of the main body housing 30, there is formed a depressed portion 38 having a lateral cross-sectional surface in a semicircular shape extending continuously to downward from the handle portion 37. The partition plate 16 is screwed on the main body housing 30 at a position extending upward from the depressed portion 38 in the front side of the handle portion 37 to form a front wall of the dust collection passage 36.

The main body housing 30 has a front surface on which an inner rib 39 smaller than and having the same shape as the skirt 35 is formed. A suction space 40 is formed inside the inner rib 39. A plurality of coupling ribs 41 projecting radially from the inner rib 39 are installed bridging between the skirt 35 and the inner rib 39. A communication port 42 communicated with the suction space 40 is formed between the partition plate 16 and the depressed portion 38 in an upper end front portion of the handle portion 37.

The pad 31 is formed of an elastic material and has an outer shape in front view in a similar shape to and slightly larger than the main body housing 30. The pad 31 has a center in which an opening 43 presenting the same shape as a shape formed along the inner rib 39 is formed. The pad 31 is arranged in a form covering between the skirt 35 and the inner rib 39 on the front surface of the main body housing 30. The pad 31 has a shallow taper shape in which the front surface retreats as approaching a side of the opening 43 from the outer periphery. The opening 43 has an inner peripheral edge on which a thin portion 44 depressed rearward over the whole circumference is formed.

The inner frame 32 is in a ring shape circulating along the thin portion 44 of the pad 31. The thin portion 44 fits to the inner frame 32 from the rear. Right and left pairs of screw mounting portions 45 are respectively formed in an upper side and a lower side in the inner peripheral side of the inner frame 32. The screw mounting portions 45 are secured by respective screws 47 into right and left pairs of screw bosses 46 disposed upright in the front-rear direction in each of the upper side and the lower side on the front surface of the main body housing 30. Thus, the pad 31 is secured, and the suction port 48 communicated with the suction space 40 in the center is formed on the front surface of the pad 31 and the inner frame 32.

The upper ends of the pad 31 and the inner frame 32 are in a chamfered shape presenting a straight line in the right-left direction as illustrated in FIG. 2 and FIG. 4.

Four contact portions 49 that project forward are formed in the upper, lower, right, and left sides on the front surface of the inner frame 32. The contact portion 49 in the upper side extends in the right-left direction according to the upper end shape of the inner frame 32. The other three contact portions 49 in the lower, right, and left sides extend in an arc shape in the circumferential direction of the inner frame 32.

Each of the contact portions 49 is formed to have a projection height with which the front surface is located in a slightly rear side with respect to the front end surface of the pad 31 as illustrated in FIG. 9 and FIG. 10 before suctioning the workpiece. In the above-described state, the taper-shaped portion of the pad 31 is in a position not being contact with the skirt 35 of the main body housing 30.

Air vent holes 50 that face the inside of the suction space 40 are formed in the main body housing 30. The respective air vent holes 50 have a rectangular shape extending in the up-down direction, and are arranged in a line in the up-down direction in the right side between the right and left screw bosses 46 in the upper side as illustrated in FIG. 2 and FIG. 4.

The air vent holes 50 are located in the right side of the handle portion 37 in the rear side. A cutout portion 51 straddling from the side surface to the rear surface of the handle portion 37 is formed in the right side of the handle portion 37. The cutout portion 51 extends in the up-down direction in a square-shaped area including the air vent holes 50. The air vent holes 50 pass through the main body housing 30 and are communicated with the cutout portion 51.

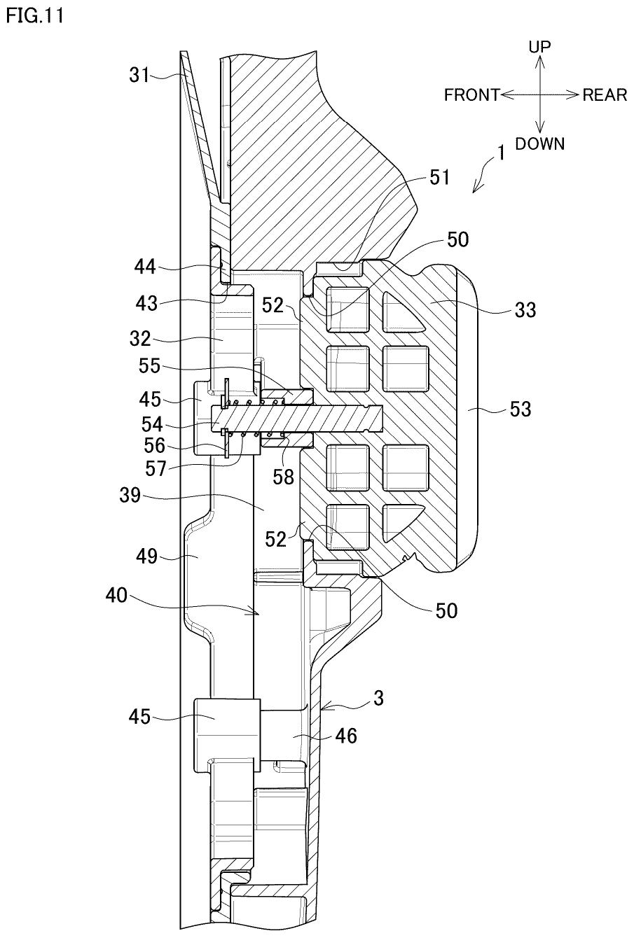

The air vent lever 33 has a square block shape fitted to the cutout portion 51 and straddling from the side surface to the rear surface of the handle portion 37. The air vent lever 33 is movable back and forth inside the cutout portion 51. The air vent lever 33 has a front surface on which a pair of upper and lower closure portions 52 are disposed to protrude. The closure portions 52 fit to the air vent holes 50 at an advance position of the air vent lever 33 being contact with a bottom surface of the cutout portion 51 to obstruct the air vent holes 50 as illustrated in FIG. 11.

The air vent lever 33 fits to the cutout portion 51 at the advance position to fit in an outer shape of the handle portion 37. A finger hook piece 53 that projects out outward to the right and obliquely rearward is integrally formed in the up-down direction between the side surface and the rear surface of the air vent lever 33. A similar finger hook piece 53A is formed on a left side surface of the handle portion 37 at a symmetrical position centered on planar surfaces in the up-down and front-rear directions passing through a center line L of the handle portion 37 with respect to the finger hook piece 53 of the air vent lever 33.

The air vent lever 33 includes a guide pin 54 that projects forward. The guide pin 54 has a rear portion integrally secured to the air vent lever 33 by insert molding between the closure portions 52. A guide cylinder 55 projecting forward is formed between the upper and lower air vent holes 50 in the main body housing 30. The guide pin 54 passes through the guide cylinder 55 from the rear side of the guide pin 54. A washer 56 retained by a circlip is mounted at a front end of the guide pin 54 in front of the guide cylinder 55.

A coil spring 57 is externally mounted at a front portion of the guide pin 54 in front of the guide cylinder 55. The coil spring 57 is interposed between a receiving depressed portion 58 formed in the inner periphery of the guide cylinder 55 and the washer 56. Accordingly, the air vent lever 33 is located at the advance position where the closure portions 52 obstruct the air vent holes 50 in an ordinary state as the result of the guide pin 54 being biased forward by the coil spring 57.

The flexible hose 4 has an upper end connected to the handle portion 37 of the main body housing 30. The flexible hose 4 fits to the depressed portion 38 of the main body housing 30 and extends downward. The flexible hose 4 has a lower end at which a pipe-shaped joint 60 is mounted.

The joint 60 has a three-tier diameter with a top portion being a large diameter portion 61 with the largest diameter, a middle portion being an intermediate diameter portion 62, and a bottom portion being a small diameter portion 63 with the smallest diameter. The intermediate diameter portion 62 has an outer periphery where grooves are formed for weight saving in the circumferential direction. The small diameter portion 63 has an outer periphery where a plurality of ring-shaped outer ribs 64 are formed in an axial direction.

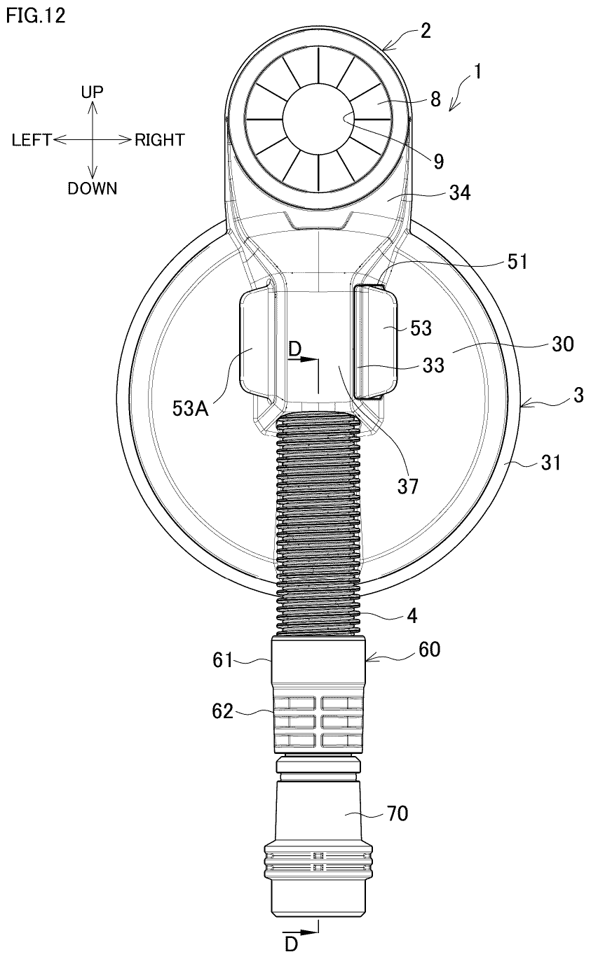

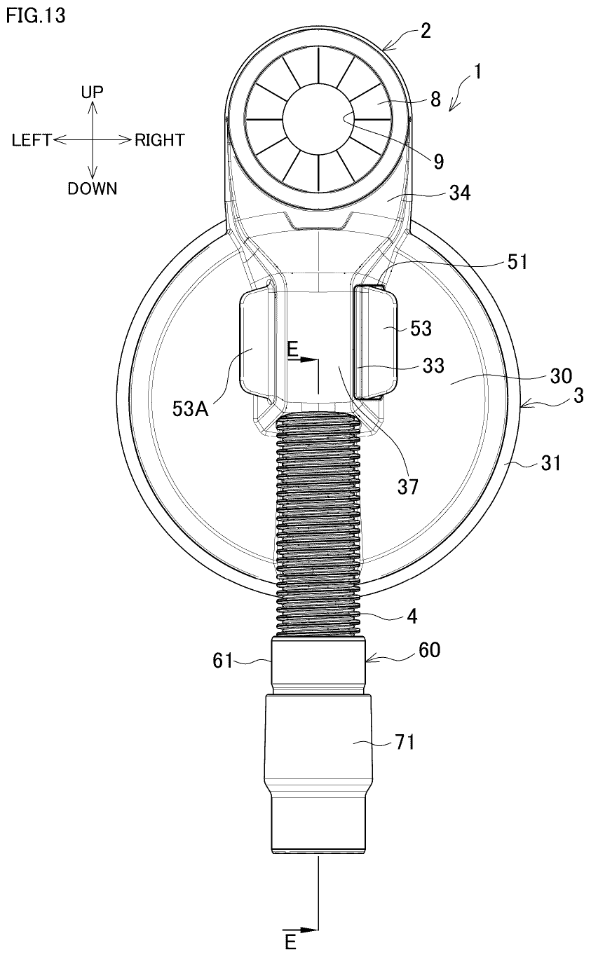

Thus, both of a cuff 70 with a small diameter illustrated in FIG. 12 and a cuff 71 with a large diameter illustrated in FIG. 13 can be connected to the joint 60.

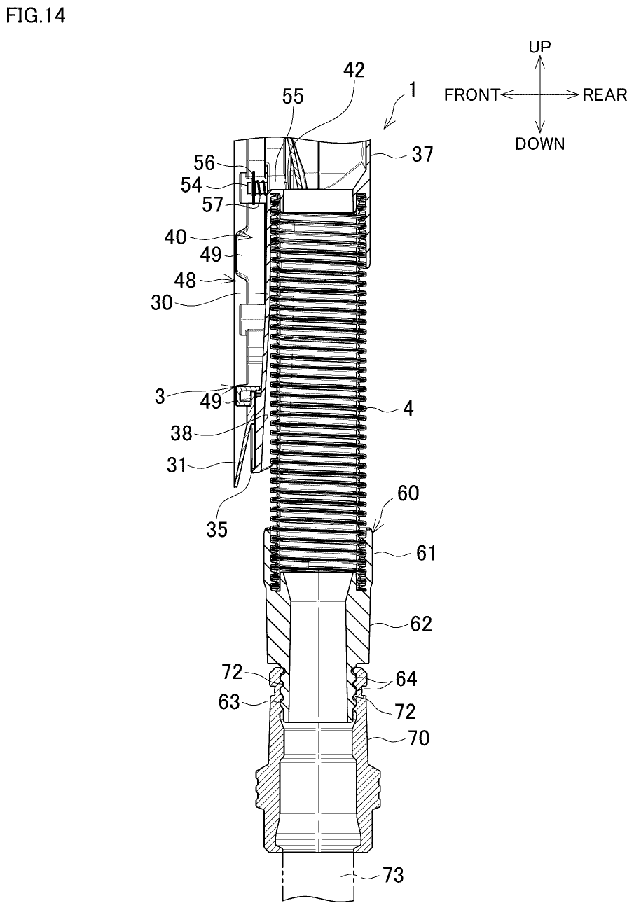

The cuff 70 with a small diameter can be connected by externally mounting a distal end on the small diameter portion 63 as illustrated in FIG. 14. The cuff 70 has an inner circumferential surface on which a plurality of ring-shaped inner ribs 72 are formed in the axial direction. The inner ribs 72 engage between the outer ribs 64 in a state the cuff 70 is connected to the small diameter portion 63 to generate a retaining effect.

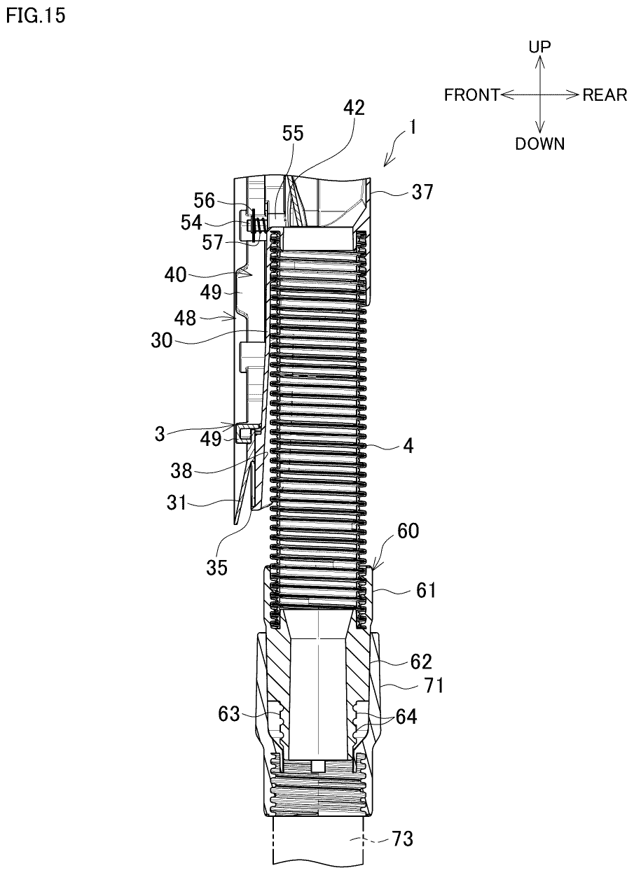

The cuff 71 with a large diameter can be connected by externally mounting and pushing a distal end to the intermediate diameter portion 62 in front of the large diameter portion 61 as illustrated in FIG. 15.

Accordingly an operator can deal with one joint 60 with any case of the distal end of an external hose 73 being the cuff 70 or being the cuff 71. Thus, the need for using the different joint 60 according to the cuffs 70, 71 is eliminated.

When the dust collecting attachment 1 configured as described above is used, the operator holds the handle portion 37 of the main body 3, positions the main body 3 on a surface of the workpiece in a vertical direction by adjusting the dust suction portion 2 at a machining position, and brings the suction port 48 into close contact with the workpiece. Driving the dust collector in the above-described state generates a suction force in the flexible hose 4 and the dust collection passage 36 via the hose 73 and generates a suction force also in the air inlet 36a of the dust suction portion 2.

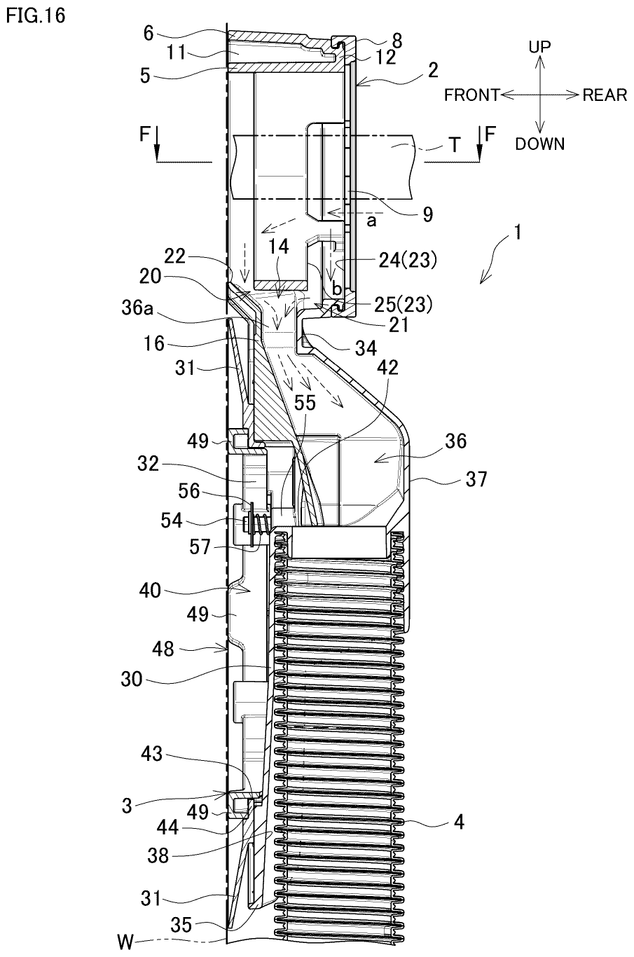

The suction space 40 of the main body 3 is communicated with the dust collection passage 36 via the communication port 42. Therefore, the air in the suction space 40 is suctioned into the dust collection passage 36 via the communication port 42 to cause the suction space 40 to have a negative pressure. Accordingly, as illustrated in FIG. 16, the suction port 48 suctions a surface of a workpiece W, and the dust collecting attachment 1 is secured on the surface of the workpiece W.

At this time, each of the contact portions 49 of the inner frame 32 has a front surface being contact with the surface of the workpiece W to restrict a further advance of the main body housing 30. Accordingly, the pad 31 is not crushed between the workpiece W and the skirt 35 of the main body housing 30, and a non-contact state with the skirt 35 is maintained.

If the pad 31 is in a state of contacting the skirt 35, when there is a projection shape on the surface of the workpiece W, the skirt 35 also ride over the projection together with the pad 31 to enlarge a gap between the pad 31 and the surface of the workpiece W, which possibly cause a reduced suction force.

However, the contact portions 49 restrict the front position of the main body housing 30 here to maintain the non-contact state between the pad 31 and the skirt 35. Therefore, even when there is a projection shape on the surface of the workpiece W, only the pad 31 deforms and rise of the main body housing 30 is avoided, thereby avoiding the reduced suction force.

In particular, in a state where the suction port 48 does not suction the workpiece W, the front surface of the contact portion 49 is located in a side of the main body housing 30 with respect to the front end surface of the pad 31.

Accordingly, even though the contact portions 49 are disposed, the close contact of the pad 31 onto the surface of the workpiece W is not interfered.

The operator then performs a drilling work by passing through a tip tool T of an electric power tool, which is not illustrated, from the rear of the dust suction portion 2. An outside air of the dust suction portion 2 is then suctioned into the inner pipe 5 from between the rubber cap 8 and the tip tool T as indicated by the dotted arrow a in FIG. 16. A part of the air suctioned into the inner pipe 5 advances in the inner pipe 5 to enter the inside of the front side dust suction flow passage 20 from the front suction opening 22. The part of the air enters the dust collection passage 36 via the air inlet 36a and reaches the dust collector via the flexible hose 4 and the hose 73 from the dust collection passage 36.

Meanwhile, the other part of the air suctioned into the inner pipe 5 flows in the inner pipe 5 to the outside in the radial direction of the inner pipe 5 as indicated by the dash-dotted arrow b to enter the inside of the rear side dust suction flow passage 21 from the inner side opening portion 25 of the rear suction opening 23. The other part of the air then joins the part of the air flowing in the front side dust suction flow passage 20 in the ventilation space 14 and enters the dust collection passage 36 from the air inlet 36a, and reaches the dust collector via the flexible hose 4 and the hose 73 from the dust collection passage 36.

Accordingly, the dust generated from the workpiece W is suctioned from any one of the front suction opening 22 or the rear suction opening 23 together with the air, enters the dust collection passage 36 from the front side dust suction flow passage 20 or the rear side dust suction flow passage 21, and is collected in the dust collector via the flexible hose 4 and the hose 73.

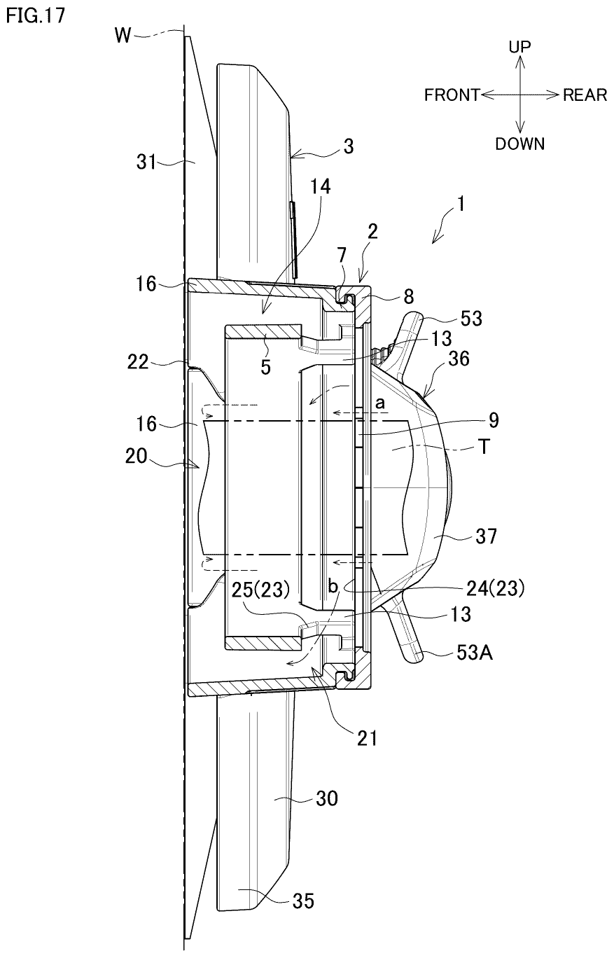

Here, the inner side opening portion 25 of the rear suction opening 23 opens over a range exceeding 180° inside the outer periphery portion of the rubber cap 8. Accordingly, the dust in the inner pipe 5 is suctioned from the rear suction opening 23 without accumulating between the inner pipe 5 and the rubber cap 8. Even when the dust collecting attachment 1 is brought into the horizontal posture, the inner side opening portion 25 is located in the lower side area of the inner pipe 5 inside the rubber cap 8 as illustrated in FIG. 17. Accordingly, the dust is suctioned into the dust collection passage 36 passing through the rear side dust suction flow passage 21 from the inner side opening portion 25. Therefore, the dust is less likely to deposit on the inner circumferential surface of the inner pipe 5 inside the outer periphery portion of the rubber cap 8.

For example, when the dust collecting attachment 1 is removed from the workpiece W for changing the machining position, the operator hooks his/her fingers on the finger hook piece 53 and the left side finger hook piece 53A of the air vent lever 33 of the handle portion 37 from the front side and pulls them rearward as it is. The air vent lever 33 then retreats against the biasing force of the coil spring 57 as indicated by the two-dot chain line in FIG. 10 to release the cutout portion 51, thereby opening the respective air vent holes 50. Accordingly, an outside air flows into the suction space 40 from the respective air vent holes 50, and thus, the suction force is reduced, thereby enabling removing the dust collecting attachment 1 from the workpiece W rearward. The removal can be performed continuously with the operation of pulling the air vent lever 33 rearward via the finger hook pieces 53, 53A. That is, the air vent by the air vent lever 33 and the removal of the dust collecting attachment 1 are not separated operations. Accordingly, the dust collecting attachment 1 can be removed by the simple operation and unexpected drop during the removal is also effectively avoidable.

When the pulling of the air vent lever 33 is released after removing the dust collecting attachment 1, the air vent lever 33 moves to the advance position by the biasing force of the coil spring 57. Accordingly, the air vent holes 50 are again obstructed by the closure portions 52.

The dust collecting attachment 1 of the above-described embodiment includes the dust suction portion 2 opposed to the surface of the workpiece W and through which the tip tool T can pass, and the main body 3 having the dust collection passage 36 communicated with the dust suction portion 2 and to which an external hose is connectable. The dust collecting attachment 1 exerts the suction force to the dust collection passage 36 from the hose 73 to cause the dust suction portion 2 to have a negative pressure.

The dust suction portion 2 includes the inner pipe 5 through which the tip tool T passes, the front side dust suction flow passage 20 that opens the front suction opening 22 to the front in the outside in the radial direction of the inner pipe 5 and is communicated with the dust collection passage 36, and the rear side dust suction flow passage 21 that opens the rear suction opening 23 to the rear in the outside in the radial direction of the inner pipe 5 and is communicated with the dust collection passage 36.

The configuration diverges the flow passages in the dust suction portion 2, thereby generating no space where the air is less likely to flow in both sides of the front and rear inside the dust suction portion 2. Accordingly, the dust is less likely to deposit inside the dust suction portion 2.

The front side dust suction flow passage 20 and the rear side dust suction flow passage 21 join in the dust collection passage 36.

Accordingly, the dust can be efficiently guided to the dust collection passage 36 even though two dust suction flow passages 20, 21 are disposed in the dust suction portion 2.

The front side dust suction flow passage 20 and the rear side dust suction flow passage 21 are disposed at least in the lower half side area in the dust suction portion 2.

Accordingly, both the dust suction flow passages 20, 21 can be brought closer to the dust collection passage 36 to shorten the flow passage, thereby reducing a pressure loss and avoiding the reduced dust collection efficiency.

The front suction opening 22 is formed to be larger than the rear suction opening 23 in the circumferential direction of the inner pipe 5.

Accordingly, the dust generated from the workpiece W can be efficiently suctioned.

The front suction opening 22 and the rear suction opening 23 are both formed at an angle of 180° or more in the circumferential direction.

Accordingly, the dust can be suctioned with both the suction openings 22, 23 located in the lower side of the tip tool T even when the dust collecting attachment 1 is used in a posture in which the dust collection passage 36 becomes horizontal, thereby being effective for avoiding the accumulation of the dust inside the dust suction portion 2.

The rear suction opening 23 is formed between the inner pipe 5 and the outer pipe 6 disposed outside of the inner pipe 5 and the ribs 13 are installed bridging between the inner pipe 5 and the outer pipe 6.

Accordingly, the rear suction opening 23 is reinforced between the inner pipe 5 and the outer pipe 6 to maintain the shape. The rib 13 reduces excessive forward deformation of the rubber cap 8.

The rubber cap 8 that seals between the passing-through tip tool T and the dust suction portion 2 is removably disposed in the rear side of the dust suction portion 2.

Accordingly, the rear side dust suction flow passage 21 can be formed using the rubber cap 8.

The rear suction opening 23 includes the rear side opening portion 24 that opens to the rear side and the inner side opening portion 25 that is communicated with the rear side opening portion 24 and opens in the inner circumference surface direction of the inner pipe 5. The rubber cap 8 obstructs the rear side opening portion 24 in the mounted state.

Accordingly, the dust likely to accumulate inside the rubber cap 8 can be efficiently suctioned from the inner side opening portion 25.

In the above-described embodiment, the following changes can be made.

The first suction opening is not limited to the configuration of the front suction opening of the above-described example. The first suction opening may have the length in the circumferential direction of the dust suction portion shorter than that of the above-described example or may be opened over the whole circumference if it is possible.

The opening width in the radial direction of the first suction opening may also be larger or shorter than that of the above-described example, or the opening width may be changed in the circumferential direction. The first suction opening may be formed by positioning the front end of the inner pipe at the same front-rear position as the front end of the outer pipe.

The second suction opening is not limited to the configuration of the rear suction opening of the above-described example. The second suction opening may have the length in the circumferential direction of the dust suction portion longer than that of the above-described example or may be opened over the whole circumference if it is possible. The second suction opening may be formed shorter at an angle less than 180° in the circumferential direction.

The second suction opening may be continuously formed in the circumferential direction by eliminating the ribs coupling between the inner pipe and the outer pipe.

The first suction opening and the second suction opening may be in the same lengths in the circumferential direction. The second suction opening may be longer than the first suction opening conversely to the above-described example.

The first and second dust suction flow passages are not limited to the configurations of the front side dust suction flow passage and the rear side dust suction flow passage of the above-described example. The first and second dust suction flow passages may be formed without making the ventilation space between the inner pipe and the outer pipe the ring shape. The first and second dust suction flow passages may be respectively independently communicated with the dust collection passage without joining in the dust suction portion.

The cap may be made of another resin, not limited the rubber cap of the above-described example. The cap may be omitted.

The obstruction structure of the air vent hole by the air vent lever is not limited to the above-described example. For example, the guide pin disposed in the air vent lever may be changed to two upper and lower guide pins instead of one guide pin, and one closure portion may be formed between the guide pins to obstruct one air vent hole disposed in the main body housing. The guide of the air vent lever is not limited to the guide by the guide pin, but a plate-shaped guiding portion may be disposed in the air vent lever. The guiding portion may be integrally formed with the air vent lever.

The shapes of the air vent hole and the closure portion are also changeable as necessary. The air vent hole and the closure portion may be a square shape or a circular shape, not a rectangular shape.

The shape of the air vent lever is not limited to the square block-shape of the above-described example. The air vent lever may be in a semicircle block shape or a rod shape.

The finger hook portion is not necessarily formed in the same projection amount in the up-down direction as the finger hook piece of the above-described example. For example, the finger hook portion may have a semicircle shape in rear view and have the large projection amount in the center in the up-down direction.

The finger hook is not necessarily in the structure projecting from the air vent lever as the finger hook piece of the above-described example. For example, the finger hook portion may be a depressed portion formed in the air vent lever.

While the air vent lever is disposed in the right side in the above-described example, the air vent lever may be disposed in the left side or may be disposed in a pair in the right and left of the handle portion.

In the present disclosure, the obstruction structure of the air vent hole by the air vent lever may be omitted.

The number and the shape of the contact portion of the inner frame are changeable as necessary. For example, the contact portion may be extended longer in the circumferential direction of the inner frame, or conversely, may be shortened.

While the front surface of the contact portion is located slightly rearward with respect to the front end surface of the pad in the above-described example, the front surface of the contact portion may be located on the same planar surface as the front end surface of the pad. Here, the planar surface is specified in the up-down and right-left direction.

In the present disclosure, the contact portion may be omitted.

The joint is changeable as necessary according to the cuff shape of the hose in the dust collector side. For example, the number of tiers with different diameters may be increased so as to be connectable corresponding to three or more types of cuffs. The connection between the joint and the cuff is not limited to the connection by engagement between the ribs or pushing. For example, screw coupling or bayonet coupling can be employed for the connection structure.

The joint may be in a configuration applicable only to one cuff.

In addition, the main body is not limited to the circular shape in rear view. Other shapes in rear view, such as a polygonal shape, a square shape, a rectangular shape, a triangular shape, and an oval shape, may be employed for the main body.

The shape of the suction port is changeable as necessary.

The shapes or the mounting structures of the pad and the inner frame are also changeable as necessary according to the main body. The suction port may be formed by using a seal member that is not a pad.

The flexible hose may be omitted. In this case, the external hose may be connected to the lower end of the handle portion.

While the dust collecting attachment suctions the workpiece in the vertical direction in the above-described example, the dust collecting attachment of the present disclosure is useable even when the workpiece is inclined or is in a horizontal direction.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A dust collecting attachment comprising:
a dust suction portion opposed to a surface of a workpiece, a tip tool being allowed to pass through the dust suction portion; and
a main body having a dust collection passage communicated with the dust suction portion and connectable to an external hose; wherein
the dust suction portion has a negative pressure by exerting a suction force to the dust collection passage from the hose,
the dust suction portion includes:
an inner pipe through which the tip tool passes;
a first dust suction flow passage that opens a first suction opening to a side of the workpiece in an outside in a radial direction of the inner pipe and is communicated with the dust collection passage; and
a second dust suction flow passage that opens a second suction opening to an opposite side of the workpiece in the outside in the radial direction of the inner pipe and is communicated with the dust collection passage.

2. The dust collecting attachment according to claim 1, wherein
the first dust suction flow passage and the second dust suction flow passage join in the dust collection passage.

3. The dust collecting attachment according to claim 1, wherein
the first dust suction flow passage and the second dust suction flow passage are disposed at least in an area in a side of the dust collection passage in the dust suction portion.

4. The dust collecting attachment according to claim 1, wherein
the first suction opening is formed larger than the second suction opening in a circumferential direction of the inner pipe.

5. The dust collecting attachment according to claim 4, wherein
the first suction opening and the second suction opening are both formed at an angle of 180° or more in the circumferential direction.

6. The dust collecting attachment according to claim 5, wherein
the second suction opening is formed between the inner pipe and an outer pipe disposed outside of the inner pipe, and a rib is installed bridging between the inner pipe and the outer pipe.

7. The dust collecting attachment according to claim 6, wherein
a ring-shaped ventilation space is formed between the inner pipe and the outer pipe, and the first dust suction flow passage serves as a flow passage that passes through the ventilation space from the first suction opening to reach the dust collection passage.

8. The dust collecting attachment according to claim 6, wherein
a ring-shaped ventilation space is formed between the inner pipe and the outer pipe, and the second dust suction flow passage serves as a flow passage that passes through the ventilation space from the second suction opening to reach the dust collection passage.

9. The dust collecting attachment according to claim 6, wherein
the outer pipe is arranged to be coaxial with the inner pipe.

10. The dust collecting attachment according to claim 9, wherein
a connecting portion that connects the inner pipe and the outer pipe on an opposite side of the dust collection passage across a common axis line of the inner pipe and the outer pipe is disposed between the inner pipe and the outer pipe.

11. The dust collecting attachment according to claim 7, wherein
the first suction opening opens into a ring shape between the inner pipe and the outer pipe.

12. The dust collecting attachment according to claim 11, wherein
an end portion of the inner pipe in the side of the workpiece is located on the opposite side of the workpiece with respect to an end portion in the side of the workpiece of the outer pipe, and the inner pipe has an axial length shorter than an axial length of the outer pipe.

13. The dust collecting attachment according to claim 1, wherein
a cap that seals between the passing through tip tool and the dust suction portion is removably disposed on the opposite side of the workpiece in the dust suction portion.

14. The dust collecting attachment according to claim 13, wherein
the second suction opening includes an opposite side opening portion that opens to the opposite side of the workpiece and an inner side opening portion that is communicated with the opposite side opening portion and opens to an inner circumferential surface direction of the inner pipe, and the cap obstructs the opposite side opening portion in a mounted state.
